(19) United States
(12) Patent Application Publication
(10) Pub. No.: US 2026/0211386 A1
(43) Pub. Date: Jul. 23, 2026

(54) DATA RECONCILIATION FOR INDUSTRIAL PROCESSES

(71) Applicant: Honeywell International Inc., Charlotte, NC (US)

(72) Inventors: Harish Iniyarajan, Chennai (IN); Minal Dani, Bangalore (IN); Karthik Upadhya, Dublin (IE); Shravan Tilak, Bangalore (IN)

(21) Appl. No.: 19/026,690

(22) Filed: Jan. 17, 2025

(51) Int. Cl. G05B 13/04

(52) U.S. Cl. CPC G05B 13/042

(57) ABSTRACT

Techniques for recommending data reconciliation for industrial operations are disclosed. Operations data, linked with an operation and including a performance indicator and correlated parameters, is received. Based on the performance indicator, it is determined whether to trigger a data reconciliation workflow. The workflow executes a computational model to identify parameters potentially correlated with the performance indicator using historical operations data. A refined subset of parameters is then identified by evaluating causal relationships with the performance indicator. Further, a valid range of values for each parameter in the refined subset is determined or computed based on a prescribed range for the performance indicator. A data reconciliation signal is then generated to render the valid range of values for each parameter in the refined subset, which may influence the performance indicator linked with the operation.

### BACKGROUND

An industrial process environment may include one or more processing facilities where a series of processes or operations may be implemented, for instance, to produce finished products. Generally, the processing facilities may be equipped with solutions to monitor and regulate various parameters associated with the operations for producing products as per requirements and/or complying with rules and regulations. Such solutions may utilize data or parameters related to an operation to derive various types of metrics or indicators related to, for example, the performance of the operation. While such derivations may be necessary and valuable, there may be instances where the underlying data is inaccurate or compromised. This may lead to inaccurate derivations of the metrics or indicators related to the operation, potentially resulting in misleading insights about the operation.

### BRIEF DESCRIPTION OF DRAWINGS

The detailed description is described with reference to the accompanying figures. It should be noted that the description and figures are merely examples of the present subject matter and are not meant to represent the subject matter itself.

FIGS. 1A to 1C illustrate a block diagram of a computing environment comprising a system, according to an example implementation of the present subject matter.

FIG. 2 illustrates a block diagram of a database illustrating the historical operations data, according to one example implementation of the present subject matter.

FIG. 3 illustrates a block diagram of the system, according to one example implementation of the present subject matter.

FIG. 4 illustrates a block diagram of a computing environment comprising the system, according to another example implementation of the present subject matter.

FIG. 5 illustrates a block diagram of operations data linked with at least one operation, according to one example implementation of the present subject matter.

FIG. 6 illustrates a block diagram of a graphical user interface indicating range of values for each parameter in a refined subset of parameters, according to one example implementation of the present subject matter.

FIG. 7 illustrates a block diagram of an exemplary method for recommending data reconciliation for industrial processes or operations, according to one example implementation of the present subject matter.

FIGS. 8A and 8B illustrate a block diagram of the exemplary method for recommending data reconciliation for industrial processes or operations, according to another example implementation of the present subject matter.

FIG. 9 illustrates a non-transitory computer-readable medium for recommending data reconciliation for at least one industrial operation, in accordance with an example of the present subject matter.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

With advancements in technology, various solutions have been developed for monitoring, controlling, and regulating parameters or variables associated with operations in processing facilities. Typically, the processing facilities are equipped with specialized solutions along with sophisticated systems to monitor and regulate various parameters, for example, temperature, pressure, flow rates, composition, and input of material to ensure product quantity, quality, and safety.

In some aspects, such solutions and control systems utilize real-time data or parameters to determine different aspects or insights related to the operations, for example, the performance of the operations, and future behaviours, and make adjustments in the parameters accordingly. Generally, the processing facilities may be equipped with various devices, for example, sensors and meters, to measure various parameters related to the operations or processes. The parameters may then be processed to determine a process function or indicator that may provide insights about the operation. For example, such indicators may indicate the overall cost of operation, operational or efficiency losses, and the like.

However, there may be multiple scenarios where inaccuracies in data and derivation of such indicators or functions may arise, potentially providing incorrect or inappropriate insights about the operations. For example, the devices used for monitoring the parameters may have certain limitations or inaccuracies. For instance, mechanical meters may often produce or transmit inaccurate measurements due to their mechanical limitations or behaviours. In another example, the data generated by the sensors may be corrupted with unwanted data or noise. Utilizing such corrupted data may consequently lead to the determination of false or inaccurate process indicators, thereby providing unexpected or inaccurate insights about the operation.

To overcome such challenges, the parameters are required to be manually and statistically modified or corrected so that accurate indicators can be obtained and, thereby, actual insights can be derived about the operations being implemented in the industrial process environment. However, such solutions face multiple challenges. For example, since the indicators or functions related to the operations are based on these underlying data or parameter values, any inaccuracy in the data or measurements directly affects the reliability of the calculated results or functions. To address the inaccuracies, expert users or solutions are required to modify the parameter values multiple times. Such an iterative correction process may be necessary to achieve more accurate process functions or indicators. However, the repeated modifications and recalculations consume significant computational resources. The increased resource usage can lead to slower overall system performance and higher operational costs. Also, the need for multiple corrections introduces delays in obtaining accurate function results, potentially slowing down decision-making processes in the industrial environment. Such delays between initial measurements and final corrected values can also hinder real-time monitoring and control of industrial processes, potentially affecting operational efficiency and product quality.

Further, the escalating complexity of industrial processes and the growing number of parameters involved exacerbate the challenges of managing corrections. As systems become more intricate, the task of adjusting and statistically reconciling data becomes increasingly complex and resource-intensive. Moreover, industrial processes often involve multiple interlinked variables or parameters that exhibit complex causal relationships. These intricate linkages can create ripple effects throughout the system, where changes or inaccuracies in one parameter may influence several others in ways that may not be directly apparent.

Identifying and understanding these complex interdependencies presents a formidable challenge. The process is not only time-consuming but also requires a deep understanding of the dynamics of the operations being implemented in the industrial process environment. Manual attempts to map these relationships may be prone to oversights and errors, particularly when dealing with subtle or non-linear interactions. Failure to accurately identify these linkages can lead to incomplete or flawed data reconciliation, potentially resulting in suboptimal process control, reduced efficiency, and increased operational risks. The complexity of these interconnected systems or processes also makes it difficult to predict the full impact of parameter adjustments, further complicating the correction process. This unpredictability can lead to unintended consequences, where attempts to improve one aspect of the process may inadvertently degrade performance in another area.

Therefore, monitoring and controlling parameters in processing facilities face significant challenges due to data inaccuracies, complex interdependencies, and resource-intensive correction processes. These issues stem from device limitations, data corruption, and the intricate nature of industrial processes. Manual modifications to address these problems are time-consuming and may lead to unintended consequences, potentially resulting in suboptimal process control, reduced efficiency, and increased operational risks. The complexity of interlinked variables further complicates efforts to achieve accurate insights and effective control of industrial operations.

The present subject matter relates to techniques for data reconciliation in industrial process environments by recommending one or more values for parameters linked with an operation associated with the industrial process environment.

According to one example, operations data may be received from the industrial process environment. The operational data may include a performance indicator and a set of parameters. In one example, the set of parameters may be variables linked with the functioning of an operation and having considerable importance for the operation. Further, the performance indicator may be, in one example, a metric linked with the output of the operation. For example, in a chemical plant, the performance indicator may be product yield and the set of parameters may include reactor temperature, pressure, and reactant flow rates. Based on the performance indicator, it may be ascertained whether a data reconciliation workflow is to be initiated. For instance, if the performance indicator is determined to be deviated from a certain threshold value or range, the data reconciliation workflow may be triggered.

Upon ascertaining that the data reconciliation workflow is to be triggered, a computational model may be executed to identify parameters potentially correlated with the performance indicator. In one example, the computational model, such as a regression-based machine learning model, may be configured with historical operations data. The historical operations data may be previously reconciled or corrected data, comprising historical performance indicators and historical parameters linked with a corresponding historical performance indicator in the set of historical performance indicators. Historical operations data may provide a foundation for understanding typical relationships between parameters and performance indicators under different operating conditions. Also, by analysing historical data, the computational model may identify long-term trends and patterns in parameter-performance relationships, helping to establish expected ranges. Thus, by being configured with such historical data, the computational model may be able to develop a mapping or logical relationship between the parameters that may be correlated with a corresponding performance indicator. By utilizing such mappings, the computational model may identify one or more parameters, from the received set of parameters, that may be correlated with the received performance indicator.

Further, from the correlated one or more parameters, a refined subset of parameters may be identified by evaluating their causal relationships with the performance indicator. The causal relationship may be evaluated, in one example, by determining a causal effect of each of the one or more correlated parameters on the performance indicator. For example, each parameter from the correlated one or more parameters may be empirically examined to determine what would have happened to the performance indicator if a particular parameter had been different while holding other factors constant. For example, one might analyse how the gasoline yield would change if the catalyst concentration were increased or decreased while keeping other parameters constant. Thus, from the received set of parameters, the refined subset of parameters may be identified, that may be the parameters actually have a direct or significant causal effect on the performance indicator as compared to other parameters in the received set of parameters.

For the refined set of parameters, a valid range of values may then be determined based on a range of values prescribed, for example by an expert user, for the performance indicator. In one example, the range of values prescribed for the performance indicator comprises an upper bound value and a lower bound value. The upper bound value and the lower bound value may define an acceptable range for the value of the performance indicator. In one example, the valid range of values for each parameter may be determined by the computational model based on a counterfactual assessment of the historical operations data and the range of values prescribed for the performance indicator. The counterfactual assessment may involve analyzing how changes in each parameter would have affected the performance indicator. This may include simulating alternative outcomes by systematically varying parameter values within the historical data. The computational model may then identify parameter ranges that consistently result in the performance indicator falling within the prescribed acceptable range. This approach may allow for the identification of parameter ranges that are likely to yield desired performance outcomes, i.e., performance indicators. Once the valid range of values is determined, a data reconciliation signal may be generated to cause a display of the valid ranges for the refined parameters.

The present subject matter provides several technical advantages for data reconciliation in industrial process environments. For example, by leveraging a sophisticated computational model trained on historical operations data, the parameters correlated, either directly or indirectly, with the performance indicators may be efficiently identified. This approach may drastically reduce the need for manual and iterative corrections, leading to substantial savings in computational resources and improvements in overall system performance.

Further, the ability to evaluate causal relationships among parameters allows for the identification of a filtered subset of truly influential parameters or factors, addressing the complex challenge of interdependencies in industrial systems. This targeted approach may enhance the precision and relevance of the data reconciliation process. Furthermore, the counterfactual assessment method employed for determining valid parameter ranges represents a data-driven approach to establishing optimal operating conditions. By simulating alternative scenarios based on historical data, parameter ranges that yield desired performance outcomes may be identified.

Furthermore, the reception of operations data, linked with an operation being implemented in the industrial environment, and subsequent generation of the data reconciliation signal with suggested parameter ranges may facilitate rapid decision-making and continuous process optimization. Such an aspect may be particularly valuable in dynamic industrial environments where quick adjustments can significantly impact factors, such as product quality and operational efficiency. Furthermore, the automated and intelligent nature of the data reconciliation workflow may address several longstanding challenges in industrial process management. For example, such a workflow may significantly reduce the time lag between initial measurements and final corrected values, enabling more responsive and accurate process control. Also, the improved reliability of calculated results enhances the quality of insights derived from process data, leading to more informed decision-making at all levels of operation.

Additionally, the approach to mapping complex parameter interactions helps in understanding and managing subtle or non-linear relationships within the industrial processes. This comprehensive view of system dynamics allows for more nuanced and effective process control. Further, by automating much of the data reconciliation process, the reliance on expert users for frequent manual adjustments may be considerably reduced. This not only saves time and human resources but also minimizes the potential for human error in the statistical reconciliation process.

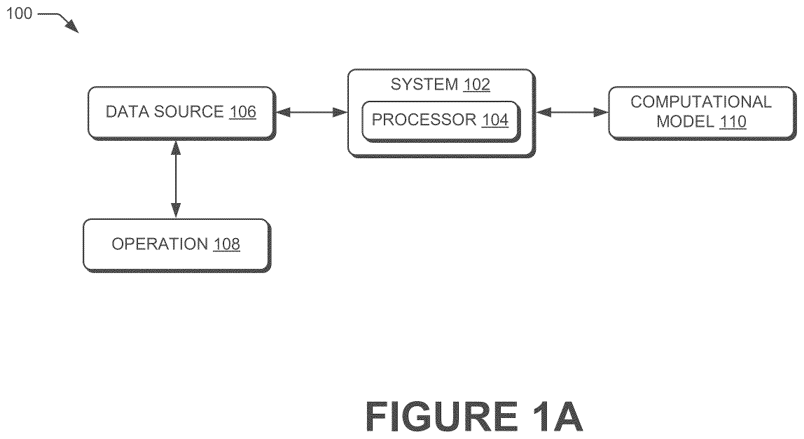

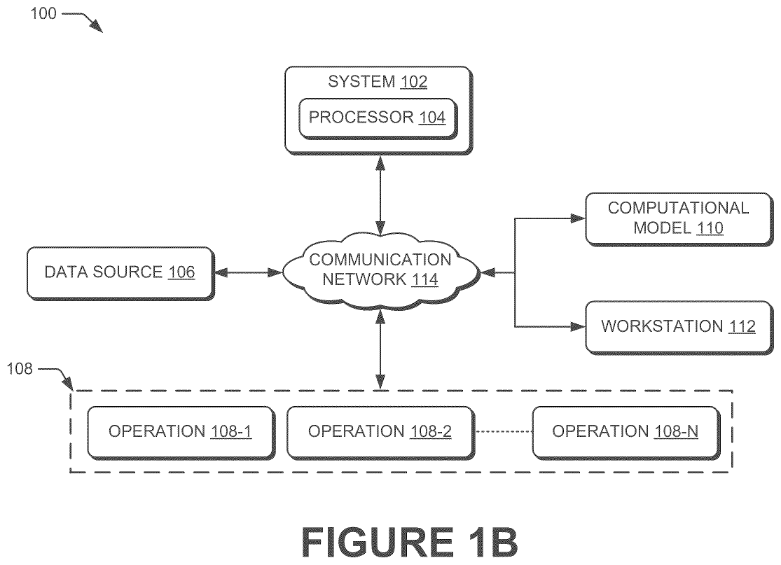

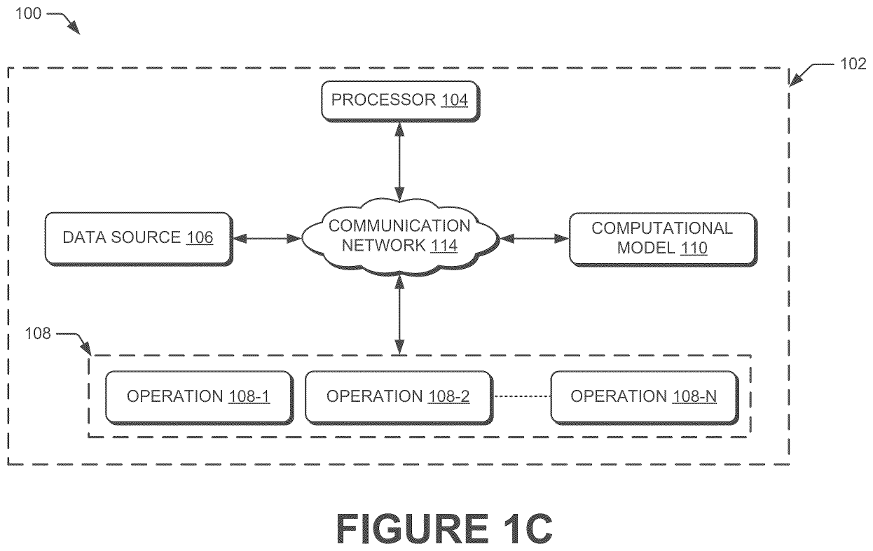

The above techniques are further described with reference to FIGS. 1A to 9. It would be noted that the description and the figures merely illustrate the principles of the present subject matter along with examples described herein and would not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIGS. 1A to 1C illustrate a block diagram of a computing environment 100 comprising a system 102, according to an example implementation of the present subject matter. FIGS. 1A to 1C will be discussed in conjunction with each other.

The computing environment 100 may be any computing environment comprising the system 102. In one example, the computing environment 100 may be an industrial process environment having one or more processing facilities associated therewith. The processing facilities may be, in one example, units where raw materials may be processed into finished products through a series of chemical, physical, mechanical, or biological operations. Examples of processing facilities may include, but are not limited to, manufacturing units, assembling units, testing units, and material processing units or plants.

The processing facilities could also be units related to different sectors. For example, the processing facilities may be related to oil and gas, petrochemicals, pharmaceuticals, food and beverage, chemical processing, metallurgical engineering, content delivery network, data management, data processing, software development and/or management, and automobile sector. Other examples of the processing facilities may also be possible.

Further, the system 102 may be configured, in one example, for recommending reconciliation of data or parameters linked with one or more operations of the industrial process environment. For example, the system 102 may be configured to receive and process operations data linked with one or more operations of the industrial process environment. Based on the operations data, the system may recommend modification or reconciliation of data or parameters, as will be discussed below. For instance, the system 102 may recommend one or more values or a range of values for the parameters, as will be discussed. In one example, the parameters may be variables correlated with the input and/or output characteristics of the one or more operations. Examples of such variables or parameters may include, but are not limited to, temperature, flow rate, speed, pressure, data size, and quantity.

In one example, the system 102 may be implemented in the computing environment 100 as a set of one or more hardware devices or modules. For example, the system 102 may be implemented as a set of one or more hardware devices, comprising at least a processor 104. The processor 104 may be implemented as a dedicated processor, a shared processor, or a plurality of individual processors, some of which may be shared. Examples of the processor 104 may include, but are not limited to, microprocessors, microcomputers, microcontrollers, digital signal processors, central processing units, state machines, Artificial Intelligence (AI) based processors, machine learning-based processors, deep learning-based processors, system-on-chip (SOC), processing circuitries including one or more modules or engines, and/or any other devices that manipulate signals and data based on computer-readable instructions.

In another example, the system 102 may be implemented as a set of computer-executable instructions. In this example, the processor 104 may be an engine capable of executing the set of computer-executable instructions that may process the operations data for data reconciliation and recommend a range of values for the parameters. Examples of the system 102, according to this example, may include, but are not limited to, software applications, cloud-based platforms, and Software as a Service (SaaS). In yet another example, the system 102 may be implemented as a combination of the one or more hardware devices and the set of computer-executable instructions. In this example, the set of computer-executable instructions may be executed by the processor 104 to process the operations data for data reconciliation and recommend a range of values for the parameters.

Further, the computing environment 100 may include a data source 106. In one example, the data source 106 may be operationally linked with the one or more operations of the industrial process environment and may be capable of generating data corresponding to the one or more parameters indicating different characteristics of the one or more operations. For example, the data source 106 may be linked with an operation 108, as illustrated in FIG. 1A, and may generate data for one or more parameters correlated with input and/or output characteristics of the operation 108. In another example, the data source 106 may be operationally linked with multiple operations, such as operations 108-1, 108-2, . . . , and 108-N as illustrated in FIGS. 1B and 1C, where N is a natural number. The operations 108-1, 108-2, . . . , and 108-N may hereinafter individually be referred to as operation 108 and collectively be referred to as operations 108. The data source 106 may be capable of generating data indicating values of the one or more parameters indicating input and/or output characteristics of each of the operations 108.

In one example, the data source 106 may include one or more devices. Examples of such devices may include, but are not limited to, sensors and meters. In another example, the data source 106 may be one or more devices or machines that may be involved in the one or more operations 108 and may be capable of generating data for the one or more operations 108.

In yet another example, the data source 106 may include a datastore storing data indicating values of the one or more parameters. For example, the datastore may be operationally linked with one or more sensors or meters associated with the one or more operations 108 and may store data, indicating values for the parameters, being generated by them. In one example, the datastore may receive and store the data indicating values of different parameters either continuously or at predefined intervals. For example, the datastore may continuously store the data being generated by the sensors and meters.

The datastore may also store, in one example, derived data, functions, or indicators that may be derived by processing the parameters. Such derived information may provide additional insights or metrics beyond the raw parameters themselves. For example, the datastore may include performance indicators that may be a function computed based on the parameters. These performance indicators may be complex functions or simple calculations that combine multiple parameters to produce a meaningful metric. Examples of such performance indicators may include, but are not limited to, efficiency metrics, statistical measures, key performance indicators (KPIs), composite scores, time-based derivatives, aggregated data that summarizes the parameters, and data indicating amount, quality, and/or quantity of the output generated by the performance of an operation. The datastore may continuously update these derived indicators as new parameter data is received, allowing for real-time monitoring and analysis of system performance. In some cases, the datastore may also store the algorithms or formulas used to calculate these indicators, enabling dynamic updates to the analysis methods. By storing parameters and derived indicators linked with the operations of the industrial process environment, the datastore may provide a comprehensive view of the overall operations linked with the industrial process environment, enabling more sophisticated analysis, reporting, and decision-making capabilities.

Further, the performance indicator and one or more parameters linked with an operation may collectively be referred to as operations data, the operations data thus being linked with the operation. In one example, the datastore may store the parameters, and the performance indicators derived from the parameters, linked with an operation in a relations or tabular format, to clearly indicate that the parameters and the performance indicators are linked with which of the operations from amongst multiple operations of the industrial process environment. Similarly, the datastore may store data for multiple operations being implemented in the industrial process environment.

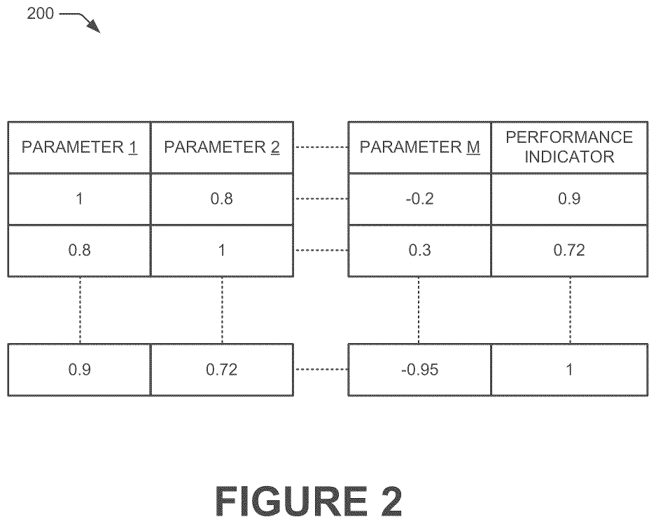

In one example, the datastore may also store historical operations data related to the one or more operations linked with the industrial process environment. The historical operations data may include parameters and performance indicators, referred to as historical parameters and historical performance indicators, respectively, collected or received historically or over a period of time for one or more operations of the industrial process environment. In one example, the historical parameters and/or historical performance indicators may be data that has already been statistically reconciled or corrected. For example, the historical parameters and/or historical performance indicators may be data collected over 90 days for one or more operations of the industrial process environment. FIG. 2 illustrates a block diagram of a database 200 illustrating the historical operations data, according to one example implementation of the present subject matter. The values indicated in the database 200 are only for illustration purposes and are not to be considered limiting. As illustrated, the database 200 may indicate values of parameter 1, parameter 2, . . . and parameter M (where M is a natural number) based on which the performance indicator for an operation may be derived. For example, based on 1, 0.8, . . . and −0.2, 0.9 (value of a performance indicator) may be derived for an operation of the industrial process environment. In one example, each row may be associated with operations data linked with a unique operations linked with one or more industrial process environments. In another example, the database 200, instead of being historical operations data, may be the operations data being generated in real-time and being added to the database 200. In yet another example, there may be multiple databases, some may include the historical operations data while others may include real-time operations data.

Further, the datastore may include, in one example, a set of storage devices capable of storing data, signals, and/or information. The set of storage devices may be virtual storage devices, physical storage devices, a cloud-based storage service, or a combination thereof. For example, the data source 106 may include any repository or storage unit implemented by physical, logical, and/or virtual storage devices. In one example, the data source 106 may include a set of physical storage devices. In another example, the data source 106 may include virtual storage devices being implemented on physical storage devices. In another example, the data source 106 may include one or more physical or logical storage units that may either be located at the same location or distributed geographically. In another example, the data source 106 may be implemented over a cloud-based storage service.

The computing environment 100 may also include, in one example, a computational model 110. The computational model 110 may be implemented as a set of algorithms, mathematical equations, or statistical methods designed to process input data and generate outputs or predictions. In another example, the computational model 110 may be implemented on a hardware device having stored thereon the set of algorithms, mathematical equations, or statistical methods. In some aspects, the computational model 110 may be based on machine learning techniques, such as neural networks, decision trees, support vector machines, or deep learning architectures. For example, the computational model 110 may be a regression-based machine learning model. In one example, the computational model 110 may be trained on historical data or simulated scenarios to learn patterns, relationships, or trends within the data, as will be discussed. In some cases, the model may be continuously updated or refined as new data becomes available, allowing it to adapt to changing conditions or improve its accuracy over time.

The computational model 110 may be used for various purposes within the computing environment 100, such as data analysis, prediction, classification, or optimization tasks. For example, the computational model 110 may process inputs from various sources, for example from the data source and/or the system 102, or user interactions, and generate outputs or recommendations that can be used for informed decision-making processes or automate certain functions within the computing environment 100. In one example, the computational model 110 may be used for identification of parameters potentially correlating with the performance indicator(s), as will be discussed.

In some implementations, the computational model 110 may be distributed across multiple computing nodes or devices within the computing environment 100, allowing for parallel processing and improved performance. The computational model 110 may also be designed to handle different types of data, including structured and unstructured data, time series, or multi-dimensional datasets. The computational model 110 may also incorporate techniques for handling uncertainty or incomplete data, such as probabilistic modeling or fuzzy logic. The model may further include mechanisms, in one example, for explainability or interpretability, providing reasoning behind its outputs or decisions. Further, in some aspects, the computational model 110 may be customizable or configurable, allowing it to be adapted for different use cases or domains within the computing environment 100. Such flexibility may enable the model to be applied to a wide range of applications, from industrial process optimization to financial forecasting.

In one example, the computing environment 100 may also include a workstation 112. In some examples, the workstation 112 may be a software-based application or tool. Examples of such tools and software may include, but are not limited to, data analysis tools, business software, websites or webpages, cloud-hosted platforms, analytical tools, and statistical tools. In some instances, the workstation 112 may be a hardware-based device. Examples of such workstation 112 may include, but are not limited to, a computing system or a desktop, a mobile, a laptop, Supervisory Control and Data Acquisition (SCADA) system. Such a workstation 112, in one example, may execute software-based applications or tools that may be accessed by a user. The user may be, for example, an engineer, a statistical reconciliation expert, or any operator or worker associated with the industrial process environment.

Further, in one example, the workstation 112 may comprise of a display device and an input mechanism. The input mechanism may be, for example, a keyboard, mouse, or even a touch input received on the display device of the workstation 112. In one example, the display device may be capable of rendering graphical user interface(s). The workstation 112 may render one or more graphical user interfaces that may indicate different information about the industrial process environment, such as the operations data linked with the operations of the industrial process environment, and the components therein. The graphical user interface may be, for example, an interactive interface with which the user may be able to interact and view different information related to the industrial process environment and/or the components therein. For example, the user may be able to view, interact, modify, and customize the information being rendered via the display device and the input mechanism associated with the workstation 112. In one example, the graphical user interface may be a dashboard that may be rendered on the display device.

Further, the system 102, the data source 106, the computational model 110, and the workstation 112 may be communicably coupled with each other to exchange data and/or signals. In one example, the coupling may be direct, either wirelessly or through one or more wires. In another example, the system 102, the data source 106, the computational model 110, and the workstation 112 may be communicably coupled via a communication network 114 to exchange data and/or signals. The computing environment 100 may thus be a network of such entities that may be communicably coupled with each other, for example, over the communication network 114 to exchange data and/or signals. Examples of the communication network 114 may include, but are not limited to LAN, WAN, the internet, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the communication network 114 may include various network entities, such as transceivers, gateways, and routers. In an example, the communication network 114 may include any communication network that uses any of the commonly used protocols, for example, Hypertext Transfer Protocol (HTTP), and Transmission Control Protocol/Internet Protocol (TCP/IP).

Thus, the computing environment 100 illustrates an example of an industrial process environment having different entities or components, and different combinations thereof, that may be communicably coupled with each other. Further, FIGS. 1A and 1B illustrate that the system 102 may be communicably coupled with the data source 106, the computational model 110, and the workstation 112. However, other implementations may also be possible. For example, the system 102 may comprise the processor 104, the data source 106, and the computational model 110, as illustrated in FIG. 1C. Similarly, different architectures may also be possible, though not illustrated.

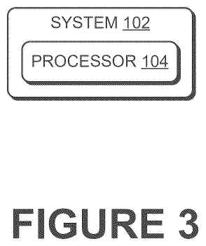

FIG. 3 illustrates a block diagram of the system 102, according to one example implementation of the present subject matter. FIG. 3 will be discussed in conjunction with FIGS. 1A to 2 for the sake of brevity and the description of FIGS. 1A to 2 shall be incorporated herein for reference. In one example, the system 102 may be configured for recommending reconciliation of operations data linked with at least one operation 108 of the industrial process environment. The system 102 comprises the processor 104 that may be configured to process the operations data linked with the at least one operation and recommend modification or reconciliation of one or more parameters.

In one example operation, the processor 104 may receive operations data linked with at least one operation 108 of the industrial process environment. The operations data may comprise the performance indicator and a set of parameters correlated with the at least one operation 108. In one example, the performance indicator may quantitatively indicate at least one aspect related to the at least one operation. based on the performance indicator, the processor 104 may ascertain whether to trigger a data reconciliation workflow capable of recommending modification of at least one of the performance indicator and the set of parameters.

In one example, the data reconciliation workflow may comprise triggering of a computational model capable of identifying one or more parameters, from amongst the set of parameters, having a potential correlation with the performance indicator. The computational model, such as the computational model 110 may be configured to identify the potential correlation based on historical operations data comprising a set of historical performance indicators and a set of historical parameters linked with a corresponding historical performance indicator in the set of historical performance indicators.

The data reconciliation workflow may comprise identifying a refined subset of parameters from amongst the one or more identified parameters by evaluating a causal relationship between each of the one or more identified parameters and the performance indicator. In one example, the causal relationship may be evaluated by determining a causal effect of each of the one or more identified parameters on the performance indicator. Once the refined subset of parameters is identified, a valid range of values may be determined for each parameter in the refined subset of parameters. In one example, the determination may be based on a range of values prescribed for the performance indicator. A data reconciliation signal may then be generated to cause rendering of the valid range of values for each parameter in the refined subset of parameters. The valid range of values may influence the performance indicator linked with the at least one operation.

Thus, the present subject matter provides techniques for data reconciliation in industrial process environments that reduce manual corrections, save computational resources, and improve system performance. Further, by evaluating causal relationships among parameters, a filtered subset of influential factors may be identified, thereby enhancing the precision of data reconciliation in a large and complex industrial environment comprising a large number of parameters, either interlinked with each other directly or hierarchically. Also, the determination of valid parameter ranges facilitates rapid decision-making and continuous process optimization. The automated and intelligent nature of the workflow addresses the challenges in industrial process management, reducing the time lag between measurements and corrected values, improving the reliability of calculated results, and enhancing decision-making. By mapping complex parameter interactions and automating the process, the present subject matter provides a comprehensive view of system dynamics, reduces reliance on expert users, and minimizes potential human errors in statistical reconciliation.

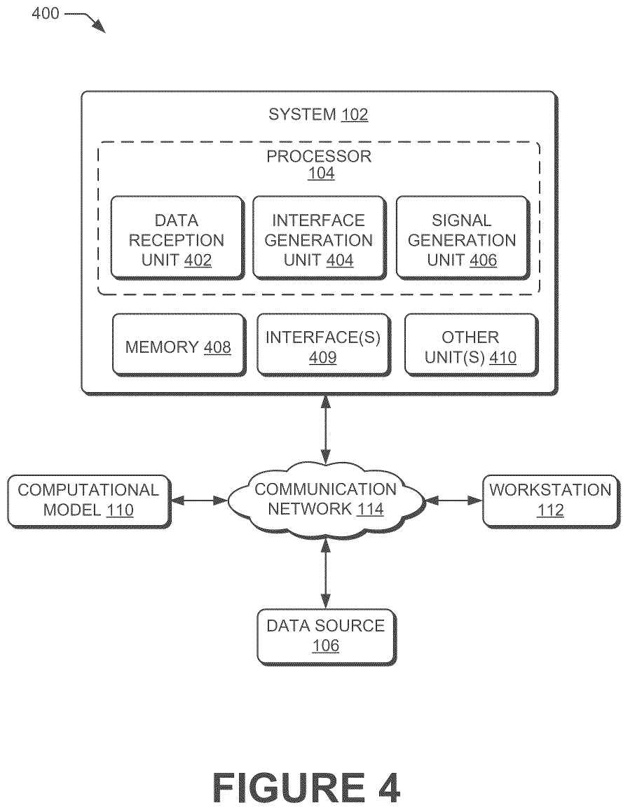

FIG. 4 illustrates a block diagram of a computing environment 400 comprising the system 102, according to another example implementation of the present subject matter. FIG. 4 will be discussed in conjunction with FIGS. 1A to 2 for the sake of brevity. The subject matter disclosed in the description of FIGS. 1A to 2 will be incorporated herein as reference for the sake of brevity.

In one example, the computing environment 400 may be similar to the computing environment 100 discussed with reference to FIGS. 1A to 1C. The computing environment 400, similar to the computing environment 100, may include the system 102, the data source 106, and the computational model 110. In one example, the computing environment 400 may also include the workstation 112. In one example, the system 102, the data source 106, the computational model 110, and the workstation 112 may be communicably coupled with each other over the communication network 114 to exchange data and/or signals.

As discussed above, the computing environment 400 may include the system 102 configured for recommending reconciliation of data or parameters linked with one or more operations of the industrial process environment. For example, the system 102 may utilize machine learning algorithms, such as the computational model 110, to analyze historical data and identify patterns or trends in the operations data. This analysis may enable the system 102 to predict, for instance, realistic parameter values or detect anomalies in real-time data streams. The system 102 may also be capable of performing multi-parameter optimization, considering complex interdependencies between different parameters to suggest optimal or desired operating conditions. The system 102 may also be capable of, in one example, incorporating real-time data from various points in the industrial process environment, allowing for dynamic adjustments and recommendations.

The system 102 may also be equipped with data visualization capabilities, presenting complex operational data and recommendations for data reconciliation in interpretable formats, such as dashboards. Further, the system 102 may have the ability to integrate with existing industrial control systems, enabling seamless data exchange and implementation of data reconciliation recommendations. In some cases, the system 102 may be capable of autonomous decision-making, automatically adjusting parameters within predefined limits or range to optimize process efficiency.

In one example, the system 102 may include the processor 104. The processor 104 may be implemented as a dedicated processor, a shared processor, or a plurality of individual processors, some of which may be shared. Examples of the processor 104 may include, but are not limited to, microprocessors, microcomputers, microcontrollers, digital signal processors, central processing units, state machines, Artificial Intelligence (AI) based processors, machine learning-based processors, deep learning-based processors, system-on-chip (SOC), processing circuitries including one or more modules or engines, and/or any other devices that manipulate signals and data based on computer-readable instructions, and/or any other devices.

In one example, the processor 104 may include one or more sub-processing units or engines. For example, the processor 104 may include a data reception unit 402, an interface generation unit 404, and a signal generation unit 406. The units may be implemented as a combination of hardware and programming, for example, programmable instructions to implement a variety of functionalities of the units. In examples described herein, such combinations of hardware and programming may be implemented in several different ways. For example, the programming for the units or engines may be executable instructions. Such instructions in turn may be stored on a non-transitory machine-readable storage medium which may be coupled with the system 102 either directly or indirectly (for example, through networked means). In an example, it may also be possible that each of the units or engines includes a processing resource, for example, a single processor or a combination of multiple processors, to execute such instructions. In one example, such instructions may be stored in a memory 408 of the system 102. The memory 408 may include any computer-readable medium known in the art including, for example, volatile memory, such as Static Random-Access Memory (SRAM) and Dynamic Random-Access Memory (DRAM), and/or non-volatile memory, such as Read Only Memory (ROM), Erasable Programmable ROMs (EPROMs), flash memories, hard disks, optical disks, and magnetic tapes. In one example, the memory may store the data received, processed, or generated by the system 102 and/or the processor 104. In other examples, the units or engines may be implemented as electronic circuitry.

The system 102 may further comprise, in one example, interface(s) 409. The interface(s) 409 may include a variety of software and hardware interfaces that allow interaction of the system 102 with other communication and computing devices, such as network entities, web servers, external repositories, control systems, and peripheral devices, such as input/output (I/O) devices. For example, the interface(s) 409 may communicably couple the system 102 with the data source 106, the computational model 110, the workstation 112, the communication network 114, and any other existing solution or control system associated with the industrial process environment. The interface(s) 409 may also enable the coupling of internal components of the system 102 with each other.

The system 102 may further comprise, in one example, the other unit(s) 410. The other unit(s) 410 may include, in one example, a power supply unit and a communication unit. The power supply unit may, for example, manage distribution or supply of electrical current within the system 102 for functioning of the system 102. Further, the communication unit may be, in one example, a wireless communication unit. Examples of the communication unit may include, but are not limited to, Global System for Mobile communication (GSM) modules, Code-division multiple access (CDMA) modules, Bluetooth modules, network interface cards (NIC), Wi-Fi modules, dial-up modules, Integrated Services Digital Network (ISDN) modules, Digital Subscriber Line (DSL) modules, and cable modules. In one example, the communication unit may also include one or more antennas to enable wireless transmission and reception of data and signals. The communication unit may allow the system 102 to be communicably coupled with the data source 106, the computational model 110, the workstation 112, and the communication network 114. Also, the communication unit may allow the system 102 to transmit and receive data, files, and/or signals.

In one example operation, the processor 104, or the data reception unit 402, may receive operations data linked with at least one operation of the industrial process environment. In one example, the operations data may be data linked with at least one operation being implemented in the industrial process environment. The operations data may be received, in one example, periodically or at regular time intervals. The regular time intervals may be defined by, for example, the user via the workstation 112. In another example, the operations data may be received in response to reception of a request from the user via the workstation 112. The request may be, for example, a request for reconciliation of the operations data linked with the at least one operation.

Further, the operations data may be received, in one example, from the data source 106. For example, in response to the user's request or at the regular time intervals, the processor 104 may access the data source to retrieve the operations data linked with the at least one process. Upon retrieval, the processor 104 may receive the operations data. In another example, the operations data may be received from the user via the workstation 112. For example, the user may submit the operations data linked with the at least one operation via the workstation 112.

In one example, the operations data may include a performance indicator quantitatively indicating an aspect about the at least one operation and a set of parameters correlated with the at least one operation. The set of parameters may include one or more parameters that may be correlated with the at least one operation 108. As discussed above in an example, the one or more parameters may indicate different characteristics of the at least one operation 108. For example, the set parameters may include one or more parameters correlated with input and/or output characteristics of the operation 108. Examples of such input characteristics may include, but are not limited to, temperature, pressure, flow rate, size, quantity, quality, and volume that may be linked with the at least one operation 108. For example, a parameter, in the set of parameters, may be an amount or volume of crude oil provided as an input to the at least one operation 108 for further processing. Further, example of the output characteristics may include, but are not limited to, temperature, pressure, flow rate, size, quantity, quality, and volume that may be linked with the at least one operation 108. For example, a parameter, in the set of parameters, may be an amount or volume of processed oil generated by the at least one operation 108. In another example, the set of parameters may include one or more parameters that may be correlated with either input or output of the at least one operation.

Thus, the set of parameters in the industrial process environment may encompass a wide range of measurable factors that influence or characterize the at least one operation 108. In addition to the previously mentioned input and output characteristics, parameters may include equipment-specific metrics such as rotational speed of turbines, vibration levels of machinery, or electrical current draw of motors. Environmental parameters like ambient temperature, humidity, or air quality may also be monitored as they can impact process efficiency. In some cases, the parameters may indicate raw material properties, such as viscosity, density, or chemical composition, that may be crucial for certain operations.

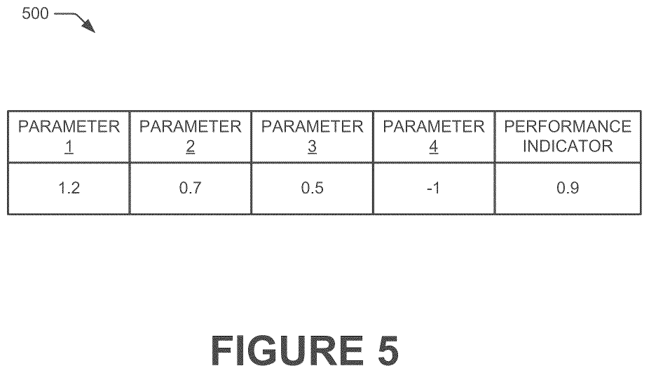

Further, as discussed above in an example, the performance indicator may be data derived based on the set of performance indicators. For example, the set of parameters may be processed through one or more mathematical functions, statistical operations, or other computational operations to obtain the performance indicator. For instance, the performance indicator may be a KPI derived by performing one or more computations/processes based on the set of performance indicators. Such derived information may provide information or insights about various aspects of the at least one operation, that may be beyond the parameters themselves. For example, a performance indicator may indicate a value for different aspects related to the at least one operation 108. Examples of such aspects may include, but are not limited to, overall equipment effectiveness, energy efficiency, product quality, defect rates, consistency of output, KPIs, composite scores, time-based derivatives, aggregated data that summarizes the set of parameters, and compliance with industry standards. These performance indicators may be derived based on complex functions or simple calculations that combine multiple parameters to produce a meaningful metric. In one example, the performance indicators, for the at least one operation 108, may have already been derived based on the set of parameters linked with that at least one operation 108 and may be received from the data source 106. FIG. 5 illustrates a block diagram of the operations data 500 linked with the at least one operation, according to one example implementation of the present subject matter. In one example, the operations data 500 may indicate values of the set of parameters, comprising parameters 1 to 4, and the value of the performance indicator derived based on the set of parameters, as exemplarily illustrated. Though illustrated as a table, the operations data, in other examples, may be received in other different formats. For example, the operations data may be a stream of data comprising the set of performance indicators and a performance indicator derived based on the set of parameters.

Based on the performance indicator, the processor 104 may ascertain whether to trigger a data reconciliation workflow capable of recommending modification of at least one of the performance indicator and the set of parameters. In one example, the processor 104 may implement the data reconciliation workflow. Further, in one example, the processor 104 may ascertain to trigger the data reconciliation workflow based on a comparison between the performance indicator and a threshold performance indicator. In one example, the threshold performance indicator may indicate a desired value for the performance indicator. The threshold performance indicator may be defined, in one example, by the user via the workstation 112. The processor 104 may compare value of the performance indicator with the value defined by the threshold performance indicator. In case the processor 104 determines that the value indicated by the performance indicator is less than the value defined by the threshold performance indicator, the processor 104 may determine that the values being indicated by the underlying set of parameters may be unacceptable, corrupted, or faulty, being a reason for the deviated value of the performance indicator. Accordingly, the processor 104 may determine the need for modification or reconciliation of data or parameters and ascertain to trigger the data reconciliation workflow. However, if the processor 104 determines that the value indicated by the performance indicator is greater than or equal to the value defined by the threshold performance indicator, the processor 104 may determine that the performance indicator is desired or acceptable. The processor 104 may therefore determine that the underlying set of parameters may be acceptable and, therefore, ascertain to avoid triggering the data reconciliation workflow.

In another example, the processor 104 may ascertain whether to trigger the data reconciliation workflow based on a comparison between the performance indicator and a range of values prescribed for the performance indicator. The range of values may be defined, in one example, by the user via the workstation 112. In one example, the data reconciliation workflow may cause rendering of an interactive user interface on the display device of the workstation 112, allowing the user to define the range of values prescribed for the performance indicator. In one example, the range of values prescribed for the performance indicator may comprise an upper bound value and a lower bound value. The upper bound value and the lower bound value may define an acceptable range of value for the performance indicator. The processor 104 may ascertain to trigger the data reconciliation workflow upon determination of non-compliance of the performance indicator with at least one of the upper bound value and the lower bound value. For example, if the processor 104 determines that the value of the performance indicator, indicated by the received operations data, deviates from the prescribed range of values, the processor 104 may ascertain to trigger the data reconciliation workflow.

Once the processor 104 ascertains to trigger the data reconciliation workflow capable of recommending modification of at least one of the performance indicator and the set of parameters, the processor 104 may trigger execution of the computational model 110. The computational model may be capable of identifying one or more parameters, from amongst the set of parameters, that may have a potential correlation with the performance indicator. To identify the potential correlation, the computational model 110 may be configured based on the historical operations data, as illustrated in FIG. 2 as one example. The historical operations data may comprise, in one example, a set of historical performance indicators and a set of historical parameters linked with a corresponding historical performance indicator in the set of historical performance indicators.

In one example, the computational model 110 may be a regression-based machine learning model that may be configured with historical operations data. The historical operations data may be previously reconciled or corrected data, comprising historical performance indicators and historical parameters. Historical operations data may provide a foundation for understanding typical relationships between parameters and performance indicators under different operating conditions. For example, based on the historical operations data, the computational model 110 may derive a reference mapping indicating a set of the historical parameters, in the historical operations data, that may be correlated with a corresponding historical performance indicator, in the historical operations data. Also, by analysing historical data, the computational model 110 may identify long-term trends and patterns in parameter-performance relationships, helping to establish expected ranges. Thus, by being configured with such historical operations data, the computational model 110 may be able to develop the mapping or logical relationship between the parameters that may be correlated with a corresponding performance indicator. By utilizing such mappings, the computational model 110 may identify one or more parameters, from the received set of parameters, that may be correlated with the received performance indicator.

In one example, the computational model 110 may be trained based on the historical operations data through a process of iterative learning and optimization. Initially, the historical operations data may be preprocessed to ensure data quality and consistency. This preprocessing step may involve handling missing values, normalizing data ranges, and encoding categorical variables if present in the historical operations data. In the training phase, the regression-based machine learning model may utilize algorithms such as linear regression, polynomial regression, or more advanced techniques like random forests or gradient boosting machines. The computational model 110 may be fed with the preprocessed historical data, where the historical parameters serve as input features and the historical performance indicators as target variables. The computational model 110 may then iteratively adjust its internal parameters or weights to minimize the difference between its predictions and the actual historical performance indicators. In one example, cross-validation techniques may be employed during the training process to ensure the model's generalizability. The historical data may be split into training and validation sets, allowing the computational model 110 to learn from one subset of data and be evaluated on another. This approach may help ensure that the computational model 110 performs well on unseen data.

In one example, the training phase of the computational model 110 may involve a structured process to learn from the historical operations data. Initially, the computational model 110 may be set up with random starting values for its internal parameters. The computational model 110 may then process the historical operations data, comparing the input parameters to the known performance indicators. For each set of historical data, the computational model 110 may make a prediction and compare it to the actual performance indicator. The difference between the prediction and the actual value, known as the error, may be calculated. The computational model 110 may then adjust its internal parameters to reduce this error, aiming to make more accurate predictions in subsequent iterations. This process of prediction, error calculation, and parameter adjustment may be repeated many times over the entire dataset. The resulting trained computational model 110 may then be capable of identifying correlations between parameters and performance indicators in new operational data.

The configured or trained computational model 110 may be used to identify parameters correlating with the performance indicator upon being triggered by the processor 104. The computational model 110 may process each parameter through its learned relationships or mapping. In one example, based on the mapping, the computational model 110 may identify the one or more parameters correlated with the performance indicator. For example, based on relationships determined based on the historical operations data, the computational model 110 may analyze the received set of parameters to identify the one or more parameters that may be correlated with the performance indicator.

In another example, the computational model 110 may compute how much each parameter influences the predicted performance indicator. Parameters that have a stronger effect on the performance indicator may be considered more correlated. To determine this influence, the computational model 110 may use various techniques. For example, the computational model 110 may slightly change one parameter while keeping others constant, and observe how much this affects the performance indicator. Parameters that cause larger changes or deviations when adjusted may be identified as more strongly correlated. In one example, the computational model 110 may compute a correlation score or metric for each parameter in the set of parameters. The correlation metric may quantitatively indicate an extent of correlation between each parameter in the set of parameters and the performance indicator. The parameters that cause larger changes may be assigned a higher correlation metric as compared to the parameters causing comparatively lesser change. The computational model 110 may also look for patterns in how parameters interact. Some parameters might have a stronger effect when combined with others. The computational model 110 may identify these complex relationships, revealing correlations that might not be obvious through simpler analysis.

Thus, for each parameter, the computational model 110 may provide a score or value, referred to as the correlation metric, indicating the extent or strength of its correlation with the performance indicator. The correlation metric could be a number showing how much the performance indicator is expected to change when the parameter changes. The computational model 110 may also indicate whether the correlation is positive or negative. A positive correlation means the performance indicator tends to increase when the parameter increases, while a negative correlation means the opposite. In some cases, the computational model 110 may be able to identify non-linear correlations or interaction effects between parameters that may not be immediately apparent through traditional statistical methods. This capability may allow for the discovery of complex, multi-faceted correlations between parameters and the performance indicator, potentially revealing insights that could be valuable for optimizing operational performance. By analyzing such aspects, the computational model 110 may provide a comprehensive view of which parameters are most strongly correlated with the performance indicator, helping to guide decisions on which parameters might be most important to monitor or adjust, thereby helping in focusing on lesser, but important, number of parameters.

The processor 104 may then identify a refined subset of parameters from amongst the one or more identified parameters by evaluating a causal relationship between each of the one or more identified parameters and the performance indicator. In one example, the causal relationship may be evaluated by determining a causal effect of each of the one or more identified parameters on the performance indicator. By evaluating the causal relationship, the processor 104 may validate whether the identified one or more parameters are actually correlated or have a causal effect on the performance indicator indicated by the received operations data.

Further, from the correlated one or more parameters, a refined subset of parameters may be identified by evaluating their causal relationships with the performance indicator. The causal relationship may be evaluated, in one example, by determining a causal effect of each of the one or more correlated parameters on the performance indicator. For example, each parameter from the correlated one or more parameters may be empirically examined to determine what would have happened to the performance indicator if a particular parameter had been different while holding other factors constant. The parameters may be systematically varied while other factors are held constant, allowing for the observation of direct effects on performance indicators. The parameters that may be identified to have a causal relationship with the performance indicators may be filtered to obtain the refined subset of parameters. In one example, parameters that may be identified to have a direct causal relationship, or up to a predefined measurable extent, with the performance indicators may be identified for the refined subset of parameters.

Other techniques could also be employed to determine the causal relationship. For example, time series analysis may be employed to examine how changes in parameters over time relate to subsequent changes in performance indicators. In some instances, SHAP analysis or Machine learning techniques may be utilized for causal analysis. For example, causal inference algorithms such as causal forests or causal trees may be employed to estimate the causal effects of parameters on performance indicators. In some cases, structural equation modeling (SEM) may be used to analyze complex causal relationships. SEM may allow for the simultaneous examination of multiple causal pathways and can account for both direct and indirect effects of parameters on performance indicators. This approach may be valuable for dealing with complex systems where multiple factors interact to influence outcomes. In practice, a combination of these methods could also be used to perform comprehensive causal analysis.

For the refined set of parameters, a valid range of values may then be determined based on the range of values prescribed for the performance indicator. The range of values may be defined, in one example, by the user via the workstation 112. For example, the interactive user interface may be rendered on the display device of the workstation 112, allowing the user to define the upper bound value and the lower bound value for the performance indicator. In one example, the range of values for the performance indicator may be defined to indicate realistic or practically appropriate values of the performance indicator, considering practical or realistic implementation of the operation 108 in the industrial process environment. This may allow for reconciliation, modification, or correction of the parameters so that a realistic or practically appropriate value of the performance indicator may be derived. In another example, the range of values for the performance indicator may be defined as values indicating desired performance outcomes from the operation 108. In one example, it may also be possible that the implementation of the operation 108 may be affected based on the modified values of the parameters.

In one example, the valid range of values for each parameter may be determined by the computational model 110 based on a counterfactual assessment of the historical operations data and the range of values prescribed for the performance indicator. The counterfactual assessment may involve analyzing how changes in each parameter, in the refined subset of parameters, would have affected the performance indicator. This may include simulating alternative outcomes by systematically varying parameter values, for example, within the historical operations data. The computational model 110 may then identify parameter ranges that consistently result in the performance indicator falling within the prescribed acceptable range, or the range of values prescribed for the performance indicator.

Thus, to perform the counterfactual assessment, the computational model 110, in one example, may generate counterfactual scenarios by systematically varying value of each parameter in the refined subset of parameters within, keeping other parameters constant. The computational model 110 may then simulate outcomes for each counterfactual scenario, predicting the performance indicator values that would have resulted from these alternative parameter settings. The computational model 110 may analyze the simulated outcomes to determine how changes in each parameter affect the performance indicator. This analysis may involve calculating the distribution of performance indicator values for each parameter setting and identifying trends or patterns in how parameter changes influence the performance indicator. Based on this analysis, the computational model 110 would determine the range of values for each parameter, in the refined subset of parameters, that consistently results in the performance indicator falling within the prescribed acceptable range. The computational model 110 may then generate outputs detailing the valid ranges for each parameter in the refined subset of parameters. This comprehensive approach may allow the computational model 110 to leverage historical data to provide data-driven insights into how different parameter settings may influence the performance indicator, enabling more informed decision-making in parameter selection and system optimization.

Once the valid range of values for each parameter in the refined subset of parameters is determined, the processor 104 may generate a data reconciliation signal to cause rendering of the valid range of values for each parameter in the refined subset of parameters. In one example, the processor 104, or the signal generation unit 406, may cause generation of the data reconciliation signal.

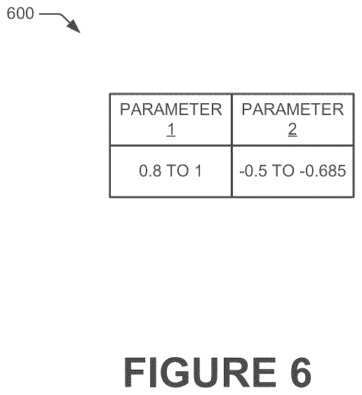

In response to generation of the signal, the processor 104, or the interface generation unit 404, may cause rendering of a graphical user interface (GUI) indicating the valid range of values for each parameters in the refined subset of parameters. For example, the processor 104 may cause rendering of a table indicating the range of values for each parameter in the refined subset of parameters. FIG. 6 illustrates a block diagram of such a graphical user interface 600 indicating the range of values for each parameter in the refined subset of parameters, according to one example implementation of the present subject matter. Consider, for instance, that the parameters 1 and 3, from the operations data 500, were identified as the result of the causal assessment. The processor 104 may cause rendering of the valid range of values for each of the parameters 1 and 3, as illustrated in FIG. 6. In one example, a single value could also be rendered instead of the range of values. For example, an average or mean of values in the valid range of values could be determined by the processor 104 and rendered on the graphical user interface 600. In one example, the graphical user interface may be rendered on the display device of the workstation 112.

Further, as the performance indicators may be derived based on the parameters, the value of the performance indicator may accordingly modify if the user adjusts or applies the recommended values of the parameters. Thus, the valid range of values may influence the performance indicator linked with the at least one operation 108 upon application of the valid range of values. Therefore, by recommending the valid range of values, modification of at least one of the performance indicator and the set of parameters may be recommended.

Further, as discussed above in one example, the data reconciliation workflow may cause rendering of the interactive user interface on the display device of the workstation 112, allowing the user to define the range of values prescribed for the performance indicator. In one example, the table or the graphical user interface 600 may be rendered on the same interactive user interface. In another example, the graphical user interface 600 may be rendered as an interface subsequent to the interactive user interface after the user submits the range of values prescribed for the performance indicator. For example, the graphical user interface 600 may be a different version or session of the interactive user interface. Thus, the graphical user interface 600 and the interactive user interface may commonly be referred to as the interactive user interface. In another example, the graphical user interface 600 and the interactive user interface may be different user-accessible interfaces that may be rendered on the workstation 112.

In one example, the interactive user interface may be capable of receiving a feedback for the determined valid range of values. The feedback may be received, for example, from the user via the workstation 112. The feedback may comprise at least one of a positive feedback and a negative feedback. In one example, the positive feedback may indicate acceptance of the determined valid range of values and the negative feedback indicating rejection of the determined valid range of values. The interactive user interface may include, in one example, a positive feedback element and a negative feedback element that may enable the user to submit the feedback. Examples of the positive feedback element and the negative feedback element may include, but are not limited to, virtual buttons, check boxes, sliders, and radio buttons being rendered on the interactive user interface. In case the user determines that the recommended range of values for the refined set of parameters is undesired or erroneous, the user may interact with the negative feedback element, via the workstation 112, to indicate unacceptance of the values being recommended. However, if the user determines that the recommended range of values for the refined set of parameters is appropriate or practically accurate for the industrial process environment, the user may interact with the positive feedback element to indicate acceptance of the values being recommended.

The feedback provided by the user may be provided or communicated, in one example, to the computational model 110. Based on the feedback, the computational model 110 may reconfigure subsequent determination of valid range of values. That is, the computational model 110 may be reconfigured over time based on the received feedbacks. The computational model 110 may thus have learning capabilities and may be capable of determining valid range of values that may be acceptable for the user and thereby appropriate for the industrial process environment.

In one example, the data reconciliation workflow may further comprise ranking each parameter, in the set of parameters, based on the correlation metric. As discussed above, the correlation metric may be computed for each parameter in the set of parameters. Thus, based on the correlation metric, each parameter in the set of parameters may be ranked. More will be the correlation metric for a parameter, higher may be the rank assigned to it. For example, a parameter having the highest correlation metric, in the set of parameters, may be ranked at the top or as 1^{st}, followed by other parameters based on decreasing correlation metric. In one example, the workflow may cause rendering of a graphical user interface to indicate each parameter, in the set of parameters, ordered based on the ranking. For example, a graphical user interface may be rendered on the display device of the workstation 112, where the parameters may be arranged or ordered based on their rankings.

Thus, by recommending the values of the parameters, the present subject matter may assist the user in the reconciliation of at least one of the performance indicator and one or more parameters and, thereby resolve data conflicts in the industrial process environments that may generally occur due to, for example, limitations or errors of the sensors, metering devices, and the like. Further, the recommendations generated may reveal optimization opportunities that would have not been detected manually, for example, by human experts, especially in an environment having multiple operations with interlinked parameters. Further, such comprehensive determination of range of values may increase accuracy of statistical reconciliation, leading to improved process or operation control and may help in financial planning by accurately presenting the process data, and identifying faulty equipment or components, such as sensors and meters.

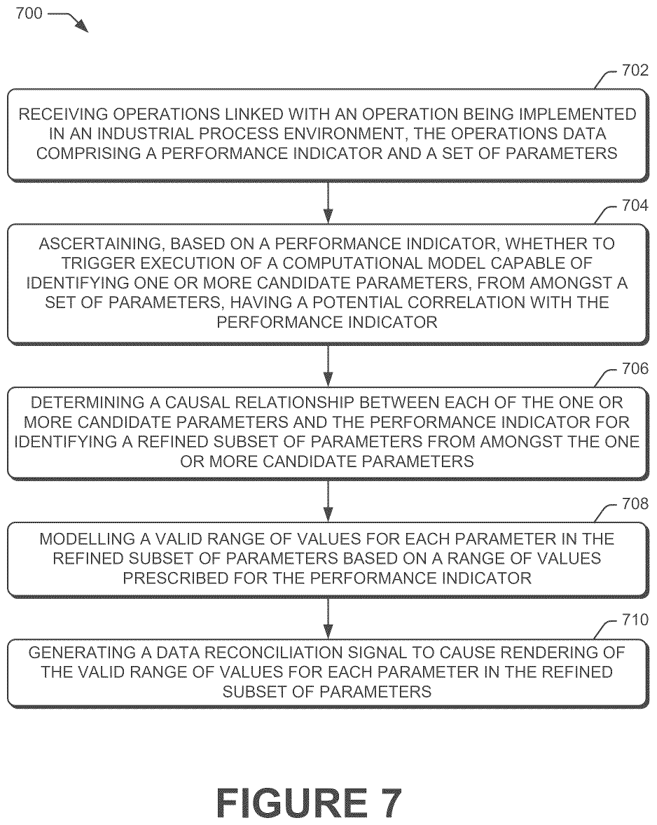

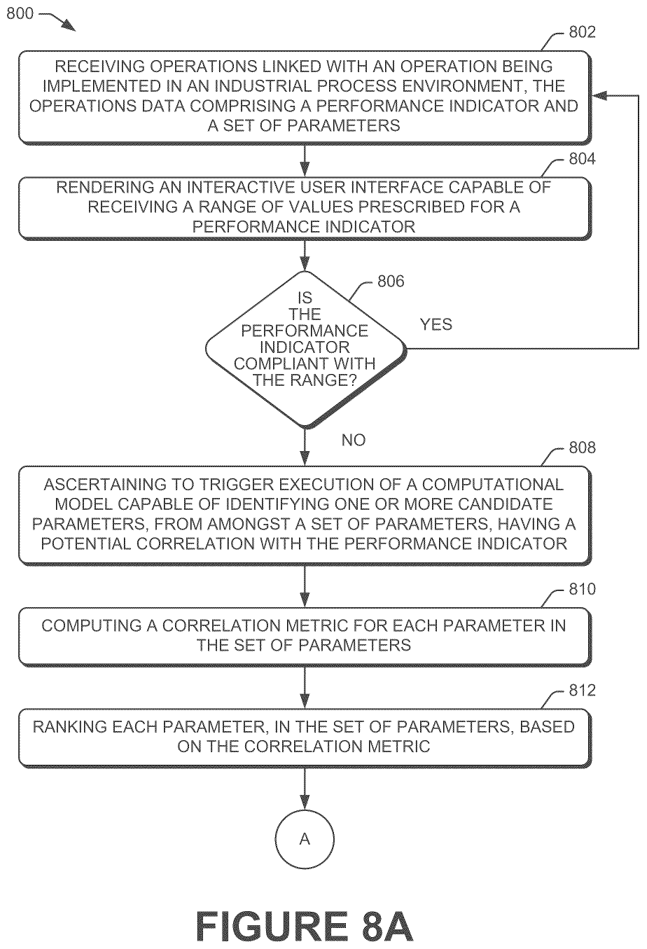

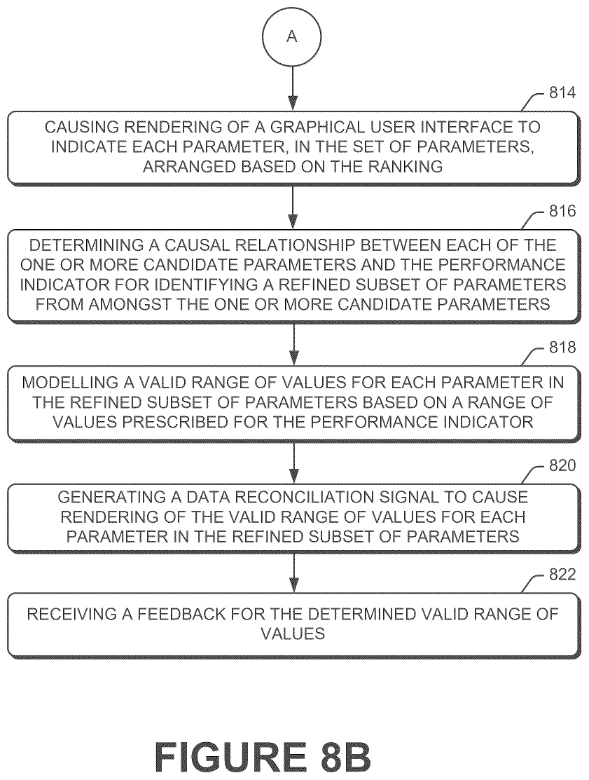

FIGS. 7 to 8B illustrate block diagrams of exemplary methods 700 and 800, respectively, recommending data reconciliation for industrial processes or operations, according to one example implementation of the present subject matter. FIGS. 7 to 8B will be discussed in conjunction with FIGS. 1A to 6. The description of FIGS. 1A to 6 has been incorporated for reference for the sake of brevity.

Further, the order in which the methods 700 and 800 are described is not intended to be construed as a limitation, and any number of the described method blocks may be combined in any order to implement the methods or alternative methods. Furthermore, the methods 700 and 800 may be implemented by processing resource(s) or computing device(s) through any suitable hardware, non-transitory machine-readable instructions, or combination thereof.

It may also be understood that methods 700 and 800 may be performed by programmed computing device(s), such as the processor 104, as depicted in FIGS. 1A to 4. Furthermore, the methods 700 and 800 may be executed based on instructions stored in a non-transitory computer-readable medium, as will be readily understood. The non-transitory computer-readable medium may include, for example, digital memories, magnetic storage media, such as one or more magnetic disks and magnetic tapes, hard drives, or optically readable digital data storage media. While the methods 700 and 800 are described below with reference to the processor 104 and the system 102 as described above; other suitable systems for the execution of these methods may also be utilized. Additionally, the implementation of the method is not limited to such examples.

FIG. 7 illustrates a block diagram of the exemplary method 700 for recommending data reconciliation for industrial processes or operations, according to one example implementation of the present subject matter.

At block 702, operations data linked with an operation being implemented in an industrial process environment may be received. The operations data may comprise a performance indicator and a set of parameters. In one example, the performance indicator may quantitatively indicate an aspect about the operation and the set of parameters correlated with input and output characteristics of the operation.

At block 704, it may be ascertained, based on the performance indicator, whether to trigger execution of a computational model capable of identifying one or more candidate parameters, from amongst the set of parameters, having a potential correlation with the performance indicator. In one example, the computational model may be modelled based on the historical operations data comprising a set of historical performance indicators and a set of historical parameters linked with a historical performance indicator in the set of historical performance indicators.

At block 706, a causal relationship may be determined between each of the one or more candidate parameters and the performance indicator for identifying a refined subset of parameters from amongst the one or more candidate parameters. For determining the causal relationship, a causal effect of each of the one or more candidate parameters on the performance indicator may be empirically evaluated.

At block 708, a valid range of values for each parameter in the refined subset of parameters may be modelled based on a range of values prescribed for the performance indicator.

At block 710, a data reconciliation signal may be generated to cause rendering of the valid range of values for each parameter in the refined subset of parameters. The valid range of values may influence the performance indicator linked with the operation upon application.

FIGS. 8A and 8B illustrate a block diagram of the exemplary method 800 for recommending data reconciliation for industrial processes or operations, according to another example implementation of the present subject matter.

At block 802, operations data linked with an operation being implemented in an industrial process environment may be received. In one example, the operations data may be linked with the operation being implemented in the industrial process environment. In another example, the operations data may be linked with an operation that may have recently been implemented in the industrial process environment. The operations data may be received, in one example, at regular time intervals. In another example, the operations data may be received in response to reception of a request from a user, for instance, via the workstation 112. The request may be, for example, a request for reconciliation of the operations data linked with the operation. Further, the operations data may be received, in one example, from a data source, such as the data source 106.

The operations data may comprise a performance indicator and a set of parameters. In one example, the performance indicator may quantitatively indicate an aspect about the operation and the set of parameters correlated with input and output characteristics of the operation. In one example, the operations data may be corrupted or erroneous data linked with the operation, and may be received for data reconciliation.

At block 804, an interactive user interface may be rendered. The interactive user interface, in one example, may be capable of receiving a range of values prescribed for the performance indicator. That is, the interactive user interface may allow a user to submit a range of values for the performance indicator. The range of values may indicate, for example, an expected or practically acceptable range of values of the performance indicator for the operation.

At block 806, it may be ascertained whether the performance metric is compliant with the range of values prescribed for the performance indicator. In one example, the value indicated by the performance indicator may be compared with the range of values prescribed for the performance indicator. Based on the comparison, it may be ascertained whether the performance metric is compliant with the range of values prescribed for the performance indicator. If it is determined that the performance indicator complies with the range of values, it may be ascertained, in one example, that there may not be a requirement to perform data reconciliation, and the method 800 may follow the YES path to block 802.

However, If it is determined that the performance indicator does not complies with the range of values, it may be ascertained, in one example, that there may be a requirement for data reconciliation, and the method 800 may follow the NO path to block 808.

At block 808, it may be ascertained to trigger execution of a computational model capable of identifying one or more candidate parameters, from amongst the set of parameters, having a potential correlation with the performance indicator. In one example, the computational model may be modelled based on the historical operations data comprising a set of historical performance indicators and a set of historical parameters linked with a historical performance indicator in the set of historical performance indicators.

The computational model, such as the computational model 110, may be capable of identifying one or more candidate parameters, from amongst the set of parameters, that may have a potential correlation with the performance indicator. To identify the potential correlation, the computational model may be configured based on the historical operations data. In one example, the computational model may be a regression-based machine learning model that may be configured with historical operations data. The historical operations data may be previously reconciled or corrected data, comprising historical performance indicators and historical parameters. Historical operations data may provide a foundation for understanding typical relationships between parameters and performance indicators under different operating conditions. For example, based on the historical operations data, the computational model may derive a reference mapping indicating a set of the historical parameters, in the historical operations data, that may be correlated with a corresponding historical performance indicator, in the historical operations data. Also, by analysing historical data, the computational model may identify long-term trends and patterns in parameter-performance relationships, helping to establish expected ranges. Thus, by being modelled with such historical operations data, the computational model may be able to develop the mapping or logical relationship between the parameters that may be correlated with a corresponding performance indicator. By utilizing such mappings, the computational model may identify one or more parameters, from the received set of parameters, that may be correlated with the received performance indicator.

At block 810, a correlation metric may also be computed for each parameter in the set of parameters. The correlation metric may indicate an extent of correlation between each parameter in the set of parameters and the performance indicator. In another example, the computational model may compute how much each parameter influences the predicted performance indicator. Parameters that have a stronger effect on the performance indicator may be considered more correlated. The parameters that cause larger changes may be assigned a higher correlation metric as compared to the parameters causing comparatively lesser change. Thus, for each parameter, the computational model may compute the correlation metric, indicating the extent or strength of its correlation with the performance indicator.

At block 812, each parameter, in the set of parameters, may be ranked based on the correlation metric. For example, parameters with higher correlation metric may be ranked higher than the parameters having comparatively lower correlation metric.

From block A and at block 814, rendering of a graphical user interface may be caused to indicate each parameter, in the set of parameters, arranged based on the ranking. In one example, the graphical user interface may be rendered on the display device of the workstation 112, where the parameters may be arranged or ordered based on their rankings. For example, the parameters may be arranged from increasing to decreasing correlation metric.

At block 816, a causal relationship may be determined between each of the one or more candidate parameters and the performance indicator for identifying a refined subset of parameters from amongst the one or more candidate parameters. For determining the causal relationship, a causal effect of each of the one or more candidate parameters on the performance indicator may be empirically evaluated.

To empirically evaluate the causal effect of each of the one or more candidate parameters on the performance indicator, various methods may be employed. For example, randomized controlled trials may be designed where a candidate parameter may be systematically varied while other candidate parameters may be held constant, allowing for measurement and analysis of resulting changes in the performance indicator. In another example, machine learning techniques like causal forests, causal boosting, or structural equation modeling may be applied to identify and quantify causal relationships in complex datasets. In yet another example, time series analysis methods may be used to detect causal relationships in time-series data by examining whether changes in one parameter precede and predict changes in the performance indicator. These methods may be used individually or in combination to determine the causal relationship and accordingly identify the refined subset of parameters.

At block 818, a valid range of values for each parameter in the refined subset of parameters may be modelled based on a range of values prescribed for the performance indicator. In one example, modelling may mean formulating the valid range of values for each parameter using a mathematical or computational representation of the relationship between the parameters and the performance indicator. This model may be used to determine range of values for each parameter that will result in the performance indicator falling within its prescribed range, i.e., the range of values prescribed for the performance indicator.

In one example, the valid range of values for each parameter may be modelled or formulated by the computational model based on the historical operations data and the range of values prescribed for the performance indicator. For example, the computational model may perform a counterfactual assessment of the historical operations data and the range of values prescribed for the performance indicator. The counterfactual assessment may involve analyzing how changes in each parameter, in the refined subset of parameters, would have affected the performance indicator. This may include simulating alternative outcomes by systematically varying parameter values, for example, within the historical operations data. The computational model 110 may then formulate or model parameter ranges that may result in the performance indicator falling within the prescribed acceptable range, or the range of values prescribed for the performance indicator.

Thus, the computational model, in one example, may generate counterfactual scenarios by systematically varying value of each parameter in the refined subset of parameters within, keeping other parameters constant. The computational model may then simulate outcomes for each counterfactual scenario, predicting the performance indicator values that would have resulted from these alternative parameter settings. The computational model may analyze the simulated outcomes to determine how changes in each parameter affect the performance indicator. This analysis may involve calculating the distribution of performance indicator values for each parameter setting and identifying trends or patterns in how parameter changes influence the performance indicator. Based on this analysis, the computational model 110 may formulate the range of values for each parameter, in the refined subset of parameters, that consistently results in the performance indicator falling within the prescribed acceptable range. The computational model 110 may then generate outputs detailing the valid ranges for each parameter in the refined subset of parameters.

At block 820, a data reconciliation signal may be generated to cause rendering of the valid range of values for each parameter in the refined subset of parameters. The valid range of values may influence the performance indicator linked with the operation upon application. In one example, generation of the signal may cause rendering of a graphical user interface (GUI) indicating the valid range of values for each parameter in the refined subset of parameters, as exemplarily illustrated in FIG. 6. In one example, the graphical user interface may be rendered on the display device of the workstation 112.

At block 822, a feedback may be received for the determined valid range of values for each parameter in the refined subset of parameters. Further, as discussed above in one example, the interactive user interface may be rendered on the display device of the workstation 112. The interactive user interface may also be capable of receiving the feedback. The feedback may comprise at least one of a positive feedback and a negative feedback. In one example, the positive feedback may indicate acceptance of the determined valid range of values and the negative feedback may indicate rejection of the determined valid range of values. The interactive user interface may include, in one example, a positive feedback element and a negative feedback element that may enable the user to submit the positive feedback and the negative feedback, respectively. Further, the feedback may be provided to the computational model. Based on the feedback, the computational model 110 may reconfigure subsequent determination of valid range of values.

In one example, the interactive user interface may also be capable of receiving a modification request from the user. For example, the interactive user interface may enable the user to modify the modelled valid range of values. As a result, the user may be provided with an option to manually modify the valid range of values as per requirements, for example, of the industrial process environment, thereby providing a flexible solution.

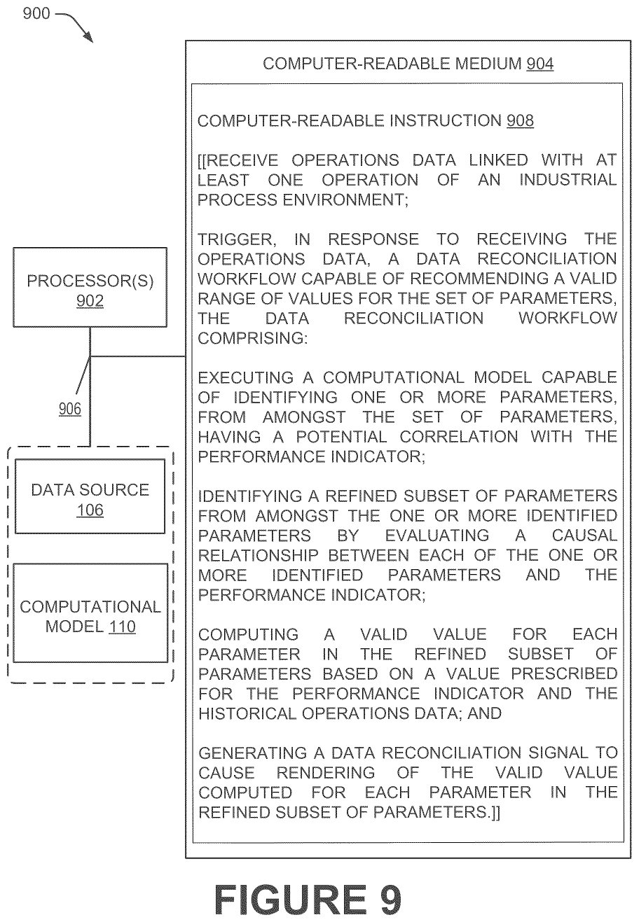

FIG. 9 illustrates a non-transitory computer-readable medium for recommending data reconciliation for at least one industrial operation, in accordance with an example of the present subject matter. FIG. 8 will be discussed with reference to FIGS. 1A to 6. The description of FIGS. 1A to 6 has been incorporated for reference for the sake of brevity.

In an example, the computing environment 900 includes a processor 902 communicatively coupled to a non-transitory computer-readable medium 904 through communication link 906. In one example, the processor 902 may include one or more processing resources for fetching and executing computer-readable instructions from the non-transitory computer-readable medium 904. The processor 902 and the non-transitory computer-readable medium 904 may be implemented, for example, in the system 102.

The non-transitory computer-readable medium 904 may be, for example, an internal memory device or an external memory. In an example implementation, the communication link 906 may be a network communication link, or other communication links, such as a PCI (Peripheral component interconnect) Express, USB-C (Universal Serial Bus Type-C) interfaces, I2C (Inter-Integrated Circuit) interfaces, etc. In an example implementation, the non-transitory computer-readable medium 904 includes a set of computer-readable instructions 908 which may be accessed by the processor 902 through the communication link 906. The processor 902 and the non-transitory computer-readable medium 904 may also be communicatively coupled to the data source 106 and the computational model 110 over the communication link 906.

Referring to FIG. 9, in one example, the non-transitory computer-readable medium 904 includes computer-readable instructions 908 that may cause the processor 902 to receive operations data linked with at least one operation of an industrial process environment. The operations data may be received, in one example, in real-time or at regular intervals from the data source 106. The operations data may comprise a performance indicator and a set of parameters. In one example, the performance indicator may quantitatively indicate an aspect about the at least one operation and the set of parameters may be correlated with the at least one operation, as discussed above.

Further, the non-transitory computer-readable medium 904 includes computer-readable instructions 908 that may cause the processor 902 to trigger a data reconciliation workflow in response to receiving the operations data. The data reconciliation workflow may be capable of recommending a valid range of values for the set of parameters. In one example, the processing resource 902 is to ascertain whether to trigger the data reconciliation workflow based on a comparison between the performance indicator and a value prescribed for the performance indicator. In one example, the processing resource 902 may cause rendering of an interactive user interface capable of receiving the value prescribed for the performance indicator. The value may be prescribed, for example, by the user.

The data reconciliation workflow may include executing the computational model 110 capable of identifying one or more parameters, from amongst the set of parameters, having a potential correlation with the performance indicator, as discussed above. The computational model 110 may be configured to identify the potential correlation based on the historical operations data comprising the set of historical performance indicators and the set of historical parameters linked with a corresponding historical performance indicator in the set of historical performance indicators, as discussed above.

Further, a refined subset of parameters may be identified from amongst the one or more identified parameters by evaluating a causal relationship between each of the one or more identified parameters and the performance indicator. The causal relationship may be evaluated by determining a causal effect of each of the one or more identified parameters on the performance indicator. For example, each identified parameter may be empirically examined to determine what would have happened to the performance indicator if a particular parameter had been different while holding other factors constant. Thus, the refined subset of parameters may be identified, which may include the parameters actually have a causal effect on the performance indicator as compared to other parameters.

For each parameter in the refined subset of parameters, a valid value may be computed based on the value prescribed for the performance indicator and the historical operations data. In one example, the valid value for each parameter may be computed by the computational model 110 based on the historical operations data and the value prescribed for the performance indicator. The valid value may be computed by the computational model 110 based on the counterfactual assessment of the historical operations data and the value prescribed for the performance indicator, as discussed above.

Once the valid value for each parameter in the refined subset of parameters is computed, a data reconciliation signal may be generated to cause rendering of the valid value computed for each parameter in the refined subset of parameters. The valid value may influence the performance indicator linked with the operation upon application. In one example, generation of the signal may cause the processing resource 902 to trigger rendering of a GUI indicating the valid value for each parameter in the refined subset of parameters.

Further, the non-transitory computer-readable medium 904 includes computer-readable instructions 908 that may cause the processor 902 to compute the correlation metric for each parameter in the set of parameters. The correlation metric may indicate or quantify an extent of correlation between each parameter in the set of parameters and the performance indicator, as discussed above. Based on the correlation metric, the each parameter, in the set of parameters, may be ranked. The processing resource 902 may further cause rendering of a GUI to indicate each parameter, in the set of parameters, ordered based on the ranking.

Further, the non-transitory computer-readable medium 904 includes computer-readable instructions 908 that may cause the processor 902 to cause rendering of the interactive user interface capable of receiving a feedback for the valid value computed for each parameter in the refined subset of parameters. The feedback may comprise at least one of a positive feedback and a negative feedback. In one example, a positive feedback may indicate acceptance of the valid value computed for each parameter in the refined subset of parameters and a negative feedback indicating rejection of the valid value computed for each parameter in the refined subset of parameters. The interactive user interface may include, in one example, the positive feedback element and the negative feedback element that may enable the user to submit the positive feedback and the negative feedback, respectively, as discussed above. In one example, the feedback may further be provided to the computational model 110, based on which, the computational model 110 may reconfigure subsequent determination of valid values for one or more parameters.

Thus, the present subject matter provides techniques for industrial data reconciliation. The present subject matter utilizes a sophisticated computational model 110 trained on the historical data to efficiently identify influential parameters, reducing manual corrections, and saving computational resources. Also, causal relationships among parameters and performance indicators may be evaluated, enhancing precision in complex industrial environments. Further, the counterfactual assessment may assist in the determination of optimal parameter value or range of values based on simulated scenarios.

Also, real-time data reception and reconciliation may facilitate rapid decision-making and continuous optimization. The automated workflow reduces the time lag between measurements and corrected values, improving process control responsiveness. Further, by automating the reconciliation process, reliance on expert users may be reduced, thereby saving time and reducing human error. These advantages result in a more efficient, accurate, and responsive data reconciliation system for industrial processes.

Although examples of the present subject matter have been described in language specific to methods and/or structural features, it is to be understood that the present subject matter is not limited to the specific methods or features described. Rather, the methods and specific features are disclosed and explained as examples of the present subject matter.

What is claimed is:

1. A system comprising:
a processor to:
receive operations data linked with at least one operation of an industrial process environment, the operations data comprising:
a performance indicator quantitatively indicating an aspect about the at least one operation; and
a set of parameters correlated with the at least one operation;
ascertain, based on the performance indicator, whether to trigger a data reconciliation workflow capable of recommending modification of at least one of the performance indicator and the set of parameters, the data reconciliation workflow comprising:
triggering execution of a computational model capable of identifying one or more parameters, from amongst the set of parameters, having a potential correlation with the performance indicator, wherein the computational model is configured to identify the potential correlation based on historical operations data comprising a set of historical performance indicators and a set of historical parameters linked with a corresponding historical performance indicator in the set of historical performance indicators;
identifying a refined subset of parameters from amongst the one or more identified parameters by evaluating a causal relationship between each of the one or more identified parameters and the performance indicator, the causal relationship being evaluated by determining a causal effect of each of the one or more identified parameters on the performance indicator;
determining a valid range of values for each parameter in the refined subset of parameters based on a range of values prescribed for the performance indicator; and
generating a data reconciliation signal to cause rendering of the valid range of values for each parameter in the refined subset of parameters, wherein the valid range of values is to influence the performance indicator linked with the at least one operation.

2. The system of claim 1, wherein the set of parameters are correlated with input and output characteristics of the at least one operation.

3. The system of claim 1, wherein the valid range of values for each parameter is determined by the computational model based on a counterfactual assessment of the historical operations data and the range of values prescribed for the performance indicator.

4. The system of claim 1, wherein the processor is to ascertain whether to trigger the data reconciliation workflow based on a comparison between the performance indicator and a threshold performance indicator.

5. The system of claim 1, wherein the processor is to ascertain whether to trigger the data reconciliation workflow based on a comparison between the performance indicator and a range of values prescribed for the performance indicator, wherein the range of values prescribed for the performance indicator comprises an upper bound value and a lower bound value, the upper bound value and the lower bound value defining an acceptable range of value for the performance indicator.

6. The system of claim 5, wherein the processor is to ascertain to trigger the data reconciliation workflow upon determination of non-compliance of the performance indicator with at least one of the upper bound value and the lower bound value.

7. The system of claim 1, wherein the data reconciliation workflow further comprises:
computing a correlation metric for each parameter in the set of parameters, the correlation metric quantitatively indicating an extent of correlation between each parameter in the set of parameters and the performance indicator;
ranking each parameter, in the set of parameters, based on the correlation metric; and
causing rendering of a graphical user interface to indicate each parameter, in the set of parameters, ordered based on the ranking.

8. The system of claim 1, wherein the data reconciliation workflow further comprises causing rendering of an interactive user interface for receiving the range of values prescribed for the performance indicator.

9. The system of claim 8, wherein the interactive user interface is capable of receiving a feedback for the determined valid range of values, wherein the feedback comprises at least one of:
a positive feedback indicating acceptance of the determined valid range of values; and
a negative feedback indicating rejection of the determined valid range of values.

10. The system of claim 9, wherein the feedback is provided to the computational model for reconfiguring subsequent determination of valid range of values.

11. A method comprising:
receiving operations data linked with an operation being implemented in an industrial process environment, the operations data comprising:
a performance indicator quantitatively indicating an aspect about the operation; and
a set of parameters correlated with input and output characteristics of the operation;
ascertaining, based on the performance indicator, whether to trigger execution of a computational model capable of identifying one or more candidate parameters, from amongst the set of parameters, having a potential correlation with the performance indicator, wherein the computational model is modelled based on historical operations data comprising a set of historical performance indicators and a set of historical parameters linked with a historical performance indicator in the set of historical performance indicators;
determining a causal relationship between each of the one or more candidate parameters and the performance indicator for identifying a refined subset of parameters from amongst the one or more candidate parameters, wherein the determining comprises empirically evaluating a causal effect of each of the one or more candidate parameters on the performance indicator;
modelling a valid range of values for each parameter in the refined subset of parameters based on a range of values prescribed for the performance indicator; and
generating a data reconciliation signal to cause rendering of the valid range of values for each parameter in the refined subset of parameters, wherein the valid range of values is to influence the performance indicator linked with the operation.

12. The method of claim 11, wherein the valid range of values for each parameter is modelled by the computational model based on the historical operations data and the range of values prescribed for the performance indicator.

13. The method of claim 11, wherein the triggering of execution of the computational model is ascertained based on a comparison between the performance indicator and the range of values prescribed for the performance indicator.

14. The method of claim 11, the method further comprising:
computing a correlation metric for each parameter in the set of parameters, the correlation metric indicating an extent of correlation between each parameter in the set of parameters and the performance indicator;
ranking each parameter, in the set of parameters, based on the correlation metric; and
causing rendering of a graphical user interface to indicate each parameter, in the set of parameters, arranged based on the ranking.

15. The method of claim 11, the method further comprises causing rendering of an interactive user interface capable of receiving at least one of:
the range of values prescribed for the performance indicator;
a feedback for the determined valid range of values, wherein the feedback comprises at least one of:
a positive feedback indicating acceptance of the determined valid range of values; and
a negative feedback indicating rejection of the determined valid range of values, wherein the feedback is provided to the computational model for reconfiguring subsequent modelling of valid range of values; and
a modification request for modifying the determined valid range of values for each parameter in the refined subset of parameters.

16. A non-transitory computer-readable medium comprising instructions, the instructions being executable by a processing resource to:
receive operations data linked with at least one operation of an industrial process environment, the operations data comprising:
a performance indicator quantitatively indicating an aspect about the at least one operation; and
a set of parameters correlated with the at least one operation;
trigger, in response to receiving the operations data, a data reconciliation workflow capable of recommending a valid range of values for the set of parameters, the data reconciliation workflow comprising:
executing a computational model capable of identifying one or more parameters, from amongst the set of parameters, having a potential correlation with the performance indicator, wherein the computational model is configured to identify the potential correlation based on historical operations data comprising a set of historical performance indicators and a set of historical parameters linked with a corresponding historical performance indicator in the set of historical performance indicators;
identifying a refined subset of parameters from amongst the one or more identified parameters by evaluating a causal relationship between each of the one or more identified parameters and the performance indicator, wherein the causal relationship is evaluated by determining a causal effect of each of the one or more identified parameters on the performance indicator;
computing a valid value for each parameter in the refined subset of parameters based on a value prescribed for the performance indicator and the historical operations data; and
generating a data reconciliation signal to cause rendering of the valid value computed for each parameter in the refined subset of parameters, wherein the valid value is to influence the performance indicator linked with the at least one operation.

17. The non-transitory computer-readable medium of claim 16, wherein the valid value for each parameter is computed by the computational model based on the historical operations data and the value prescribed for the performance indicator.

18. The non-transitory computer-readable medium of claim 16, wherein the processing resource is to ascertain whether to trigger the data reconciliation workflow based on a comparison between the performance indicator and the value prescribed for the performance indicator.

19. The non-transitory computer-readable medium of claim 16, wherein the processing resource is to:
compute a correlation metric for each parameter in the set of parameters, the correlation metric indicating an extent of correlation between each parameter in the set of parameters and the performance indicator;
rank each parameter, in the set of parameters, based on the correlation metric; and
cause rendering of a graphical user interface to indicate each parameter, in the set of parameters, ordered based on the ranking.

20. The non-transitory computer-readable medium of claim 16, wherein the processing resource is to cause rendering of an interactive user interface capable of receiving at least one of:
the value prescribed for the performance indicator;
a feedback for the valid value computed for each parameter in the refined subset of parameters, wherein the feedback comprises at least one of:
a positive feedback indicating acceptance of the valid value computed for each parameter in the refined subset of parameters; and
a negative feedback indicating rejection of the valid value computed for each parameter in the refined subset of parameters, wherein the feedback is provided to the computational model for reconfiguring subsequent computations of valid values.
